(19) United States
(12) Patent Application Publication
(10) Pub. No.: US 2004/0134234 A1
(43) Pub. Date: Jul. 15, 2004

(54) Lens production method and process

(76) Inventors: Oded Katzman, Haifa (IL); Youval Katzman, Zichron Yaacov (IL)

Correspondence Address: NATH & ASSOCIATES, PLLC, Sixth Floor, 1030 15th Street, N.W., Washington, DC, 20005, US

(21) Appl. No.: 10/693,665

(22) Filed: Oct. 27, 2003

(30) Foreign Application Priority Data
Nov. 14, 2002 (IL) 152834

(51) Int. Cl. C03C 19/00

(52) U.S. Cl. 65/61; 65/323

(57) ABSTRACT

A method for processing a first optical face and a second optical face of a lens, where a lens blank is positioned and gripped by a gripping device relying on reference datum indications rendering it possible to obtain topographic orientation for processing both faces of the lens, and wherein not more then one reference datum indication extends on a face of the lens.

### FIELD OF THE INVENTION

This invention relates to a method and a process for manufacturing an optical lens. In particular the invention is concerned with gripping the blank during the process of forming the topography of the optical faces of the lens.

The term blank or lens blank as used herein in the specification and claims, denotes a work-piece from which the lens is manufactured according to any forming process.

### BACKGROUND OF THE INVENTION

Each optical lens comprises two optical surfaces, each formed with some physical characteristics (lens topography), the combined effect of these two surfaces when positioned relative to each other impart the lens with a desired optical performance. These characteristics fall in two categories:

I. Surface quality, of both optical surfaces, affecting the ability of the surface to be transparent to light.

II. Surface topography, of both optical surfaces, influencing the direction of the light as it passes through the lens.

These characteristics are obtained by different process by which the surfaces of the lens are formed, by different means and at different processes, as known in the art.

The surface topography is achieved by one or more of processes such as grinding, cutting, machining, molding, etc. The surface quality is achieved by processes such as smoothing, lapping and polishing. These and other procedures for obtaining the lens surface are referred to herein the specifications and claims as processing.

According to any of the processes mentioned above and as known in the art, the lens blank has to be firmly griped in the respective machine while the surface is being processed.

A common practice in the optical industry, for holding a lens blank during process, is to adhere the lens to a so-called blocking element, also referred to as a ‘blocker’ or a ‘blocking chuck’. The blocker is attached to the lens at the surface not being processed.

The blocker is made of a hard material such as Aluminum or stainless steel and usually has a typical and standard shape that provides for easy attachment of the blocker to conventional gripping means of the machine while the lens is adhered to it, such that the lens blank can be easily and safely processed by the machine tools.

The process of adhering the blocker to the lens or lens blank is referred to in the art as blocking. The hard blocking material may damage the surface of the already formed lens surface. In some cases adherence of the blocker to the lens may be insufficiently strong. In order to ensure strong and safe attaching of the blocker to the lens, some preparations are needed.

One commonly used method of protecting the lens surface is by applying a protective tape (also known as surface saver) over the lens. This tape is a plastic tape with an adhesive face for adhering to the lens by a dedicated taping system (‘surface saver applicator’), and the blocker is attached to the other face of the tape.

Another method of protecting the lens is by applying on to the lens a material that dries and hardens and remain as a coating layer on the lens surface. Such a material may be applied for example by spraying.

However, the surface of the lens must be clean prior to taping or spaying and therefore requires some particular care and attention during the process. For that purpose, in some lens production lines, a cleaning step is introduced prior to protecting step.

The first step in blocking the lens is precisely positioning the blocker with respect to the lens. In some cases, the position of the lens with respect to the blocker is critical. Miss positioning of the lens on the blocker may lead to poor optical performance of the final lens. In order to ensure an accurate positioning of the lens of the blocker, an enlarging imaging device is used whereby the operator views the lens and moves the lens over the blocker, until pre-marked reference marks on the lens surface appear in a predetermined position.

According to one process, the operator is required to position the lens such that a point printed at the geometrical center of the lens appears at the center of the lens blocker. A printing machine is used for printing the reference mark and in most cases printing takes place prior to protecting by tape or spray. Once the operator confirms that the lens is in the right position, a temporary clamping device is used to make sure the lens doesn't move during the next step.

The adhering material used for attaching the lens to the blocker is, by one form, a special alloy known as “Wood Alloy”. This alloy melts at low temperature to ensure minimum risk for damaging the lens. Typically the melting temperature is in the range of about 47° C. to 85° C. alternatively, a special wax is used for that purpose.

A typical blocking system comprises a hot reservoir of melted alloy or wax, a m mechanical system to hold the blocker, a vision or imaging system for viewing the lens and the reference marks at large scale. During the blocking process, when the operator confirms that the lens is properly positioned with respect to the blocker, the alloy is pumped to fill the gap between the blocker and the lens.

Once the alloy or wax cools, it hardens such that the lens and the blocker are rigidly attached to one another, and now the other face of the lens may be formed.

The process disclosed above requires several steps which is time consuming and where accuracy is dependant up to great extent on the skills of the operator and on his vision, which is a differing and un-reliable parameter.

### SUMMARY OF THE INVENTION

According to a broad aspect of the invention there is provided a method for processing both optical faces of a lens, where gripping and orientating the lens with respect to griping means of a lens processing equipment is carried out by relying on full-spatial orientation (three-dimensional) reference datum indications such that not more then one reference datum indication extends on an optical surface of the lens, to obtain true position of the lens. According to some particular embodiments, all reference datum indications are formed out of the optical face of the lens, i.e. all said reference datum indications are formed on peripheral portions of the lens.

The term true position denotes positioning and orientation of an object with respect to another object or geometric location, at an unequivocal position. Typically such positioning is facilitated by mechanical reference datum indications.

By its broad aspect, the invention calls for manufacturing the optical faces of a lens where gripping and processing are carried out while a lens blank is gripped at peripheral surfaces thereof.

The invention suggests a method for processing optical faces of a lens wherein gripping a lens blank during processing optical faces of the lens is carried out by gripping the blank at portions of the blank having a radius greater then that of the processed optical faces.

A lens blank processed according to a method of the present invention is mechanically gripped to thereby constitute at least part of the full-spatial orientation reference datum. At times, further indicia may be imparted to the lens for optically setting. Optical setting denotes relying on optical parameters for true positioning of the lens blank, where man or machine vision is required.

The method according to an embodiment of the present invention comprises the following steps:

Obtaining a lens blank;

Gripping the lens blank by a gripping device for use in conjunction with a lens production machine;

At the same grip, processing the lens blank to obtain a full-spatial reference datum indications and processing a first optical face of the lens whereby said reference datum indications define the coordinates of the lens with respect to said first optical face; and wherein not more then one reference datum indication extends on an optical surface of the lens;

Turning over the lens blank and gripping it while relying on said reference datum indications; and

Processing a second optical face of the lens.

The gripping device, as referred to herein after in the specification and claims, may be integral with the lens production machine or detachably fixable thereto.

According to a first modification of the first embodiment of the invention, after processing the first optical face of the lens, a removable structural support material is molded into a cavity formed at said first optical face, to thereby hold/support, reinforce and increase rigidity of the lens during processing the second lens face. Preferably, some anchoring means are formed at a front side of the partially processed lens, such as a peripheral recess or indentions, to increase attachment of the structural support material to the lens. Still preferably, the finished surface of the first optical face is coated with a protective material prior to applying the structural support material. Other finishing processes may also be carried out at that stage.

The term finishing, as used herein the specification and claims denotes final process applied to the optical face of the lens, after completing its topography, such as different polishing methods, various coatings and treatings etc.

When a structural support material has been applied to the first optical face, and upon completing processing the second lens face, the optical geometry of the lens is complete upon removing excessive peripheral portions and it may then be removed from the support material.

A method according to a second modification of the first embodiment of the present invention comprises the following steps:

Obtaining a lens blank;

Gripping the lens blank by a gripping device used in conjunction with a lens production machine;

Processing the lens blank to obtain a full-spatial reference datum indications and processing a first optical face of the lens, whereby said reference datum indications define the coordinates of the lens with respect to said first optical face; not more then one reference datum indication extends on an optical surface of the lens;

Blocking the first optical face of the lens to a blocking chuck, where reference datum of the blocker is in register with the reference datum of the lens blank;

Gripping the blocking chuck by a gripping device of a lens production machine; and

Processing a second optical face of the lens.

According to another aspect of the invention, there is provided a lens blank pre-formed with full-spatial reference datum indications, whereby the blank may than be gripped by a gripping device for use in conjunction with a lens processing machine, relying on said reference datum indicia, for processing both optical faces of the lens. The coordinates determined by the reference datum indications provide spatial information corresponding with the complexity of the lens concerned. Required. However, not more then one reference datum indication extends on an optical surface of the lens and according to some embodiments, all reference datum indications extend out of the optical face of lens. It is however appreciated that the lens blank is pre-formed with all reference datum indications, or with at least one such reference datum indication, whereby further reference datum indications are formed on the lens blank as may be required, depending on the lens type and optical complexity.

Also, the lens blank may be partially pre-formed with one or both of the first and second optical face curvatures i.e. be pre-formed with some optical topography.

By a modification of the invention, the reference datum indications are provided by an adapter assembly wherein the lens blank is received by a first component adapted for engagement with a second component associated with the gripping device; wherein said first component and said second component are formed with corresponding reference datum engagement portions. The lens blank may be fixedly attached or molded within said first component, being for example an adapter ring.

### BRIEF DESCRIPTION OF THE DRAWINGS

For better understanding the invention and to see how it may be carried out in practice, some embodiments will now be described, by way of some non-limiting examples only, with reference to the accompanying drawings, in which:

FIGS. 1A to 1C are side views of lens blanks according to several embodiments of the inventions;

FIG. 1D illustrates an example of gripping a lens blank as in FIG. 1A by a lens gripping device;

FIGS. 2A to 2G are isometric views illustrating consecutive steps in preparing a lens according to a method of the present invention, the lens being partially cutaway;

FIG. 3 is a cutaway isometric view of an optical lens;

FIGS. 4A to 4F are isometric views illustrating consecutive steps in preparing a lens according to another method of the present invention; and

FIG. 5A is a cutaway of a subassembly illustrating a lens blank fixedly received by an adapter used in conjunction with a gripping device; and

FIG. 5B is a cutaway of the subassembly of FIG. 5A fixed within a gripping device of a lens performing apparatus.

### DETAILED DESCRIPTION OF THE INVENTION

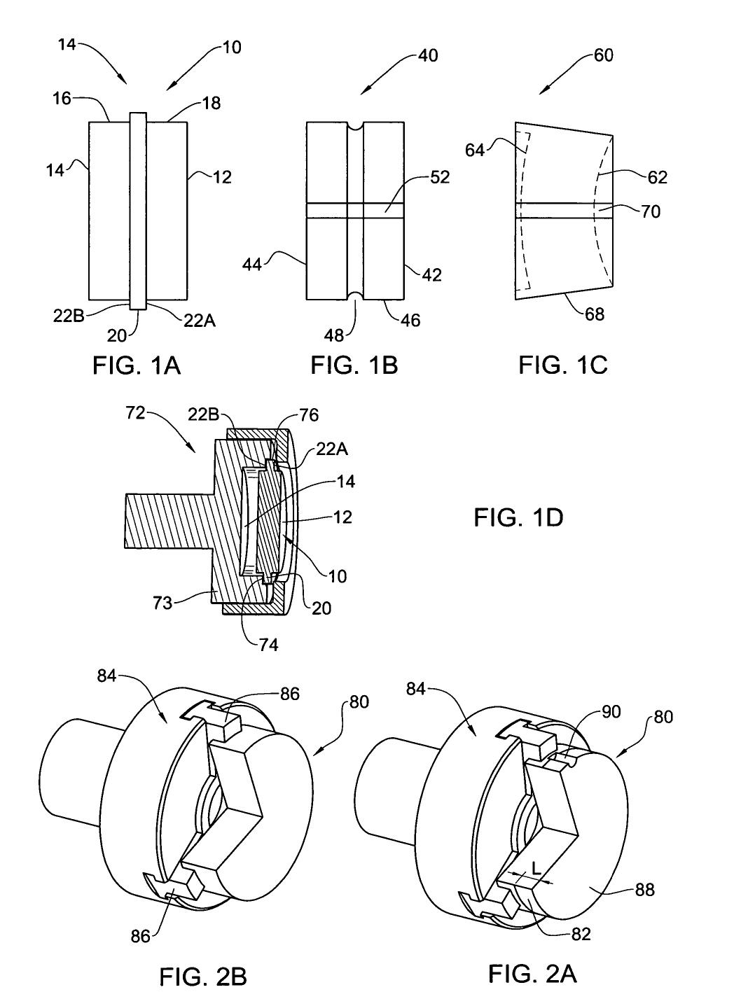

Attention is first directed to FIGS. 1A to 1C of the drawings illustrating several examples of lens blanks in accordance with the present invention. In FIG. 1A lens blank 10 is a highly translucent cylindrical body having a first face 12, a second face 14 and a peripheral portion comprising two generally cylindrical portions 16 and 18 separated from one another by an annular radially extending rim 20. Faces 12 and 14 are non-optical faces, i.e. are not formed with optical topography. Generally cylindrical face 16 and an annular, radially extending rim 20 serving as a reference datum.

Rim 20 comprises two shoulders 22A and 22B extending parallel to one another and at a right angle with respect to surface 16. Furthermore, the axial distance between the shoulders 22A and 22B is of known value.

The reference datum is indicative of the orientation of the lens blank 10 while gripped in a conventional machining chuck of a lens processing equipment such that the lens blank 10 is gripped at either of its portions 16 or 18 relying on said rim 20. In accordance with the embodiment of FIG. 1A a first optical lens face and a second optical lens face may be processed.

In the embodiment of FIG. 1B there is illustrated a lens blank generally designated 40 being an essentially cylindrical body formed with a first non-optical face 42, a second non-optical face 44 and a cylindrical peripheral face 46 separated by an annular groove 48 providing axial reference datum whilst an axially extending recess 52 provides for lens orientation in one axis. The combination of recesses 48 and 52 provides sufficient datum for processing the first and second optical lens surfaces (optical topography).

Turning now to the embodiment of FIG. 1C, there is illustrated still a different embodiment of a lens blank in accordance with the present invention generally designated 60 where the first optical lens face 62, illustrated by a dashed line, is roughly preformed and similarly, the second optical face 64, also illustrated by a dashed line, is roughly preformed. However, it is to be appreciated that the first and second faces 62 and 64, respectively may be already complete as far as their optical topography, or may be near to complete or only partially formed. The peripheral surface of the lens blank 60, designated at 68 is a tapering wall providing axial orientation for the lens blank with an axially extending recess 70 formed in the peripheral wall providing at least one degree of spatial reference datum for orientation of the lens.

A lens blank in accordance with the present embodiment comprises mechanical reference datum for determining the orientation of at least a first lens face whereupon after processing said first optical face, the second optical face may be processed with said first optical face further serving as different datum for processing the second optical face.

FIG. 1D is an example of how a lens blank 10, according to the embodiment of FIG. 1A is fixedly gripped by a gripping device generally designated 72 and comprising a base member 73 fitted with a neck portion 74 for gripping by a chuck of a machining apparatus (not shown) and a lens-blank bearing shoulder 75 for supporting shoulder 22B of the lens blank 10 (see FIG. 1A). A locking member 76 is suited for tightly and fixedly engaging the base member 73, e.g. by screw fastening, such that it bears against shoulder 22A of rim 20 of the lens blank, thus fixedly clamping it, whereby the lens blank nay be processed, e.g. by machining.

Whilst embodiments have been illustrated and exemplified in connection with a lens blank according to the present invention, it is to be appreciated that many other forms of such lens blanks may be formed, for use with a variety of lens gripping devices, without departing from the scope of the invention.

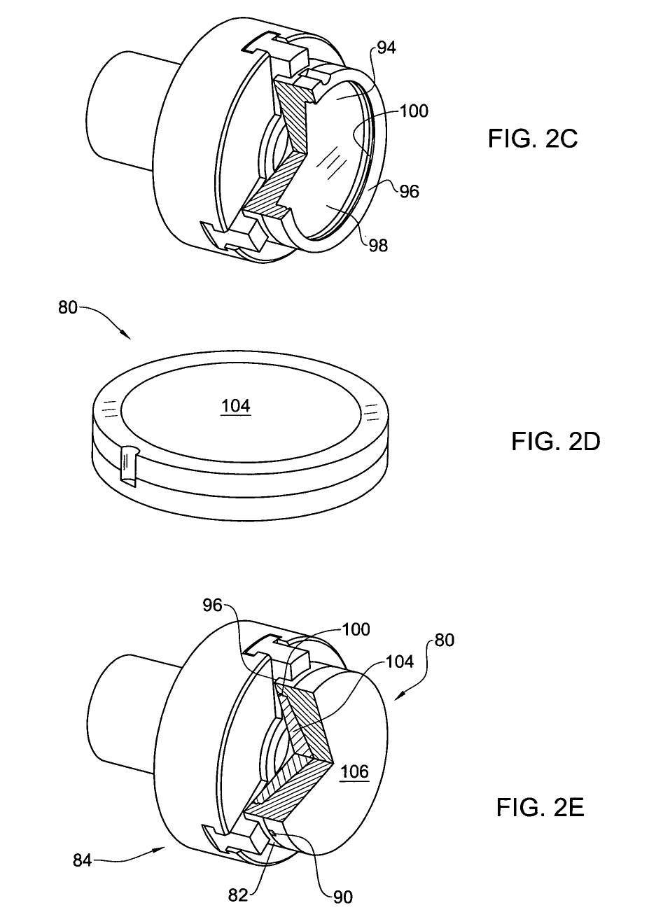

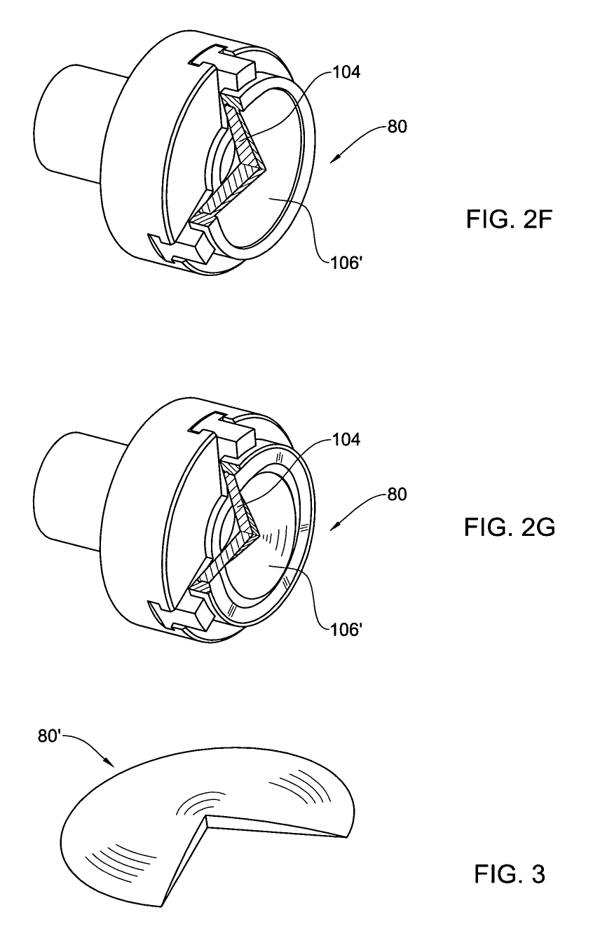

Turning now to FIGS. 2A through 2G, there is illustrated a first method for manufacturing a lens in accordance with the present invention. At a first step, a generally cylindrical lens blank 80 is obtained and is gripped by a conventional chuck generally designated 84 of a lathe (not shown). The lens blank 80 is secured to the chuck 84 by a plurality of radially displaceable chuck jaws 86 and where the lens blank 80 tightly bears against the jaws 86 eliminating axial and radial degrees of freedom.

At a first processing step (FIG. 2B) the lens blank 80 is precisely machined to form a circumferential cylindrical surface 82 coaxial with the axis of the chuck 84 and having a predetermined axial length L, measured from a first optical face 88 of the lens blank 80, which has been leveled to extend normal to the axis of the blank. Further, an axial recess 90 is formed on the periphery of the blank, aligned with the axial axis thereof. The cylindrical surface 82, the length L and the axial recess 90, constitute full-spatial orientation reference datum indications, whereby precise coordination of the lens are now available, providing complete orientation of the lens.

Once the mechanical reference datum 90 has been formed, the first optical face of the lens 94 is processed (machined), leaving a peripheral shoulder 96, thus forming a cavity designated 98. A radial peripheral undercut recess 100 is formed in the peripheral shoulder 96 (FIG. 2C), the purpose of which will become apparent with reference to the following Figures.

At a further step (FIG. 2D) a structural support material 104 in liquid form is molded, or otherwise applied, to the cavity 98 formed at the first optical face of the lens 80 and is allowed to harden and to solidify with the lens blank. The structural support material is, for example, a so-called wood alloy which is a material having a relatively low temperature (typically in the range of about 47° C. to 85° C.) or a special wax. Upon hardening, the structural support material 104 is well received within the cavity 98 and firmly received within groove 100 thereof, thereby allows for applying radial inwardly directed force for gripping the lens blank, as will become apparent with reference to FIGS. 2E-2G. Furthermore, the structural support material 104 reinforces and increases rigidity of the lens and reduces vibrations caused during the processing of the second optical face of the lens, upon axial progress of the machining/processing equipment and thinning of the lens.

Upon curing of the structural support material 104, the length 80 is turned over and secured to the chuck 84 such that a second optical face 106 of the lens 80 is now facing upwards and is ready for being processed. However, gripping of the lens 80 within chuck 84 is carried out by relying on the already machined reference datum indications, namely the front face of the peripheral shoulder 96 (and the length L), the peripheral cylindrical surface 82 and the axial recess 90, for ensuring correct positioning of the lens 80 with respect to the chuck 84, such that the first and second optical faces of the lens are processed in correct orientation with respect to one another and with correct topography. This arrangement ensures correct orientation and coordination between both faces of the lens.

In FIG. 2F, the lens 80 is illustrated in a position where the second lens face 106′ is almost completed, whereas in FIG. 2G processing of the lens is complete where peripheral portions of the lens have been removed and where the finished lens 80′ is secured by adhesion only by the structural support material 104. The lens 80′, in its finished form, is seen in FIG. 3, after removing from the structural support material.

It is to be noted that in some cases, prior to applying the structural support material on the finished lens surface, it may be necessary to apply some protective coating to increase adhesion of the structural support material to the lens surface and to prevent damage to the lens surface.

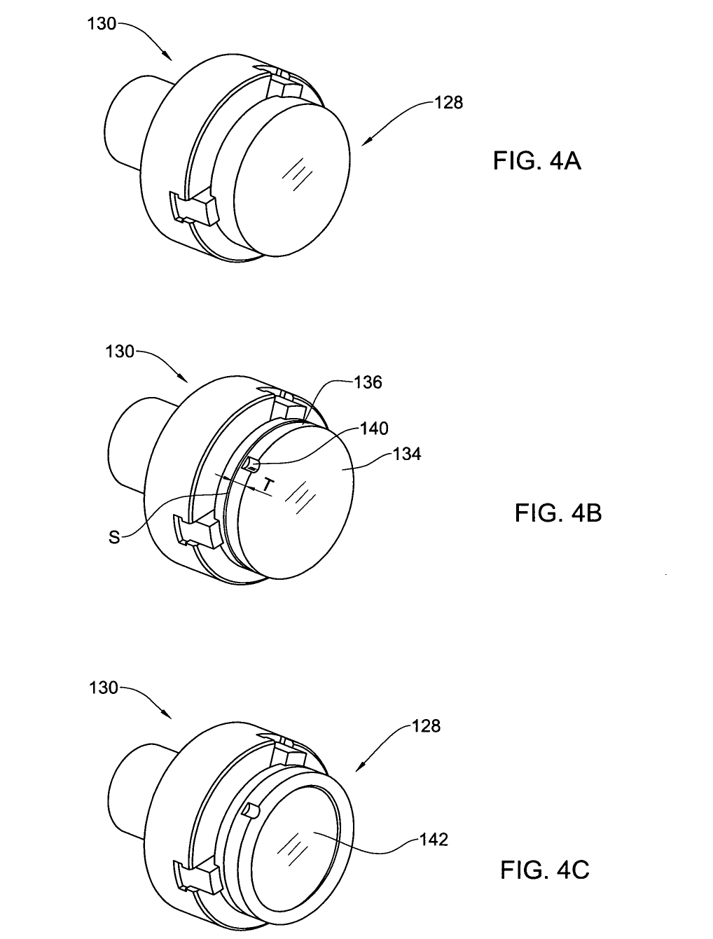

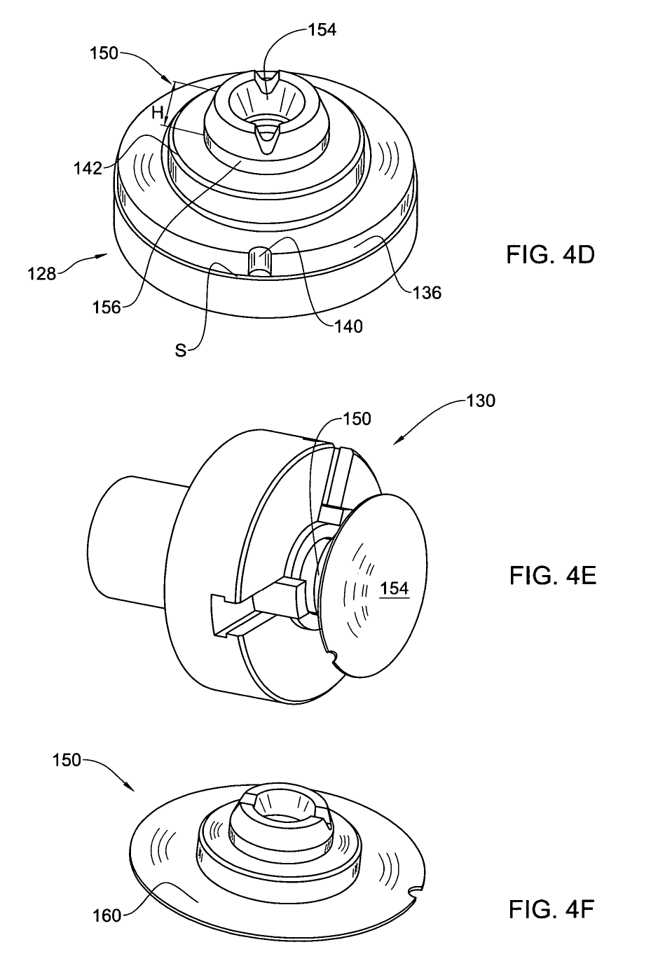

Turning now to FIGS. 4A-4G there is illustrated how a lens may be manufactured in accordance with a second method of the present invention. At a first step, a lens blank 128 is obtained and secured to a chuck 130. Lens blank 128 is of any form and shape, i.e. not necessarily preformed with any surface datum. Once the blank is securely received within the chuck 130, a first machining/processing step takes place where the front lens surface 134 is leveled (FIG. 4B) thereby constituting a first reference datum indication surface and then a circumferential cylindrical surface 136 is processed, having a thickness T and forming an annular shoulder S to provide for a rotational datum indication, an axial recess 140 is machined on the peripheral surface 136, all as similar to the embodiment as illustrated in FIG. 2B. The above surfaces constitute full-spatial orientation reference datum indications, whereby precise coordinations and orientation of the lens are now available.

Then, the first optical face 142 of the lens is finalized (FIG. 4C) and the lens blank 128 is removed from the chuck 130. However, in some cases the optical topography of the first optical face may be completed, whereas final finishing (e.g. polishing, coating, etc) is carried out after completing the topography of the second optical face. A blocker chuck 150 is then attached to the first surface 142 of the lens blank 128, typically by applying some protective tape (surface saver), to thereby protect the lens surface on the one hand, and, on the other hand, to increase adhesion of the blocker to the lens.

The blocker 150 is a metallic article formed with reference datum indications, e.g. chuck-engaging recesses 154, accurately machined cylindrical surface 156 and the overall height H of the chuck portion of the blocker 150 which together constitute full-spatial orientation reference datum indications, whereby precise co-ordinations and full orientation of the lens are available. It is however appreciated that the blocker 150 is attached to the lens blank 128 at true-position relation ensuring that the reference datum indications of the blocker 150 is in register with the reference datum indications performed (machined) on the lens blank 128, as explained in connection with FIG. 4B.

The assembled lens blank and blocker are then attached to the chuck 130 in a tight manner and relying on the reference datum indications of the blocker 150, whereby the second surface of the blank 154 is machined (FIG. 4E). Upon completing the second lens surface 154 the blocker 150 may be removed from the chuck (FIG. 4F) though a peripheral residual portion 160 is still to be removed prior to obtaining a final lens as illustrated in FIG. 3.

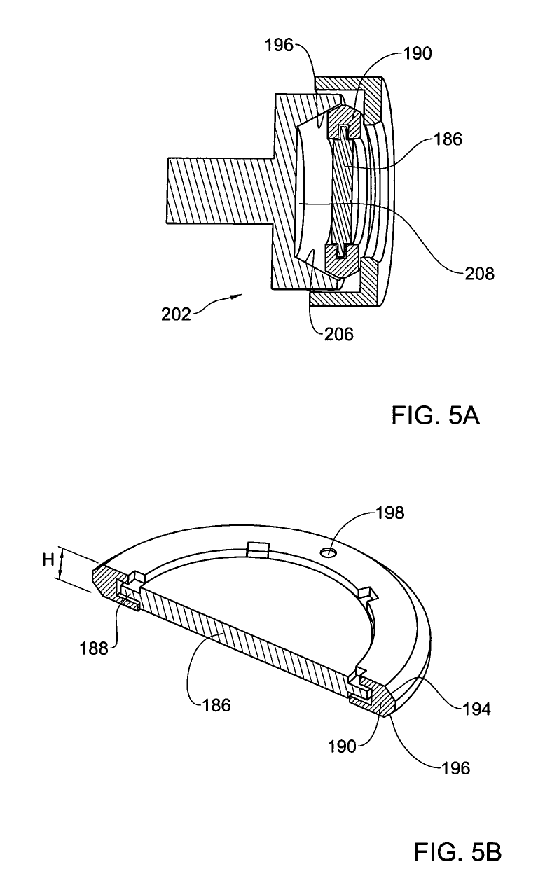

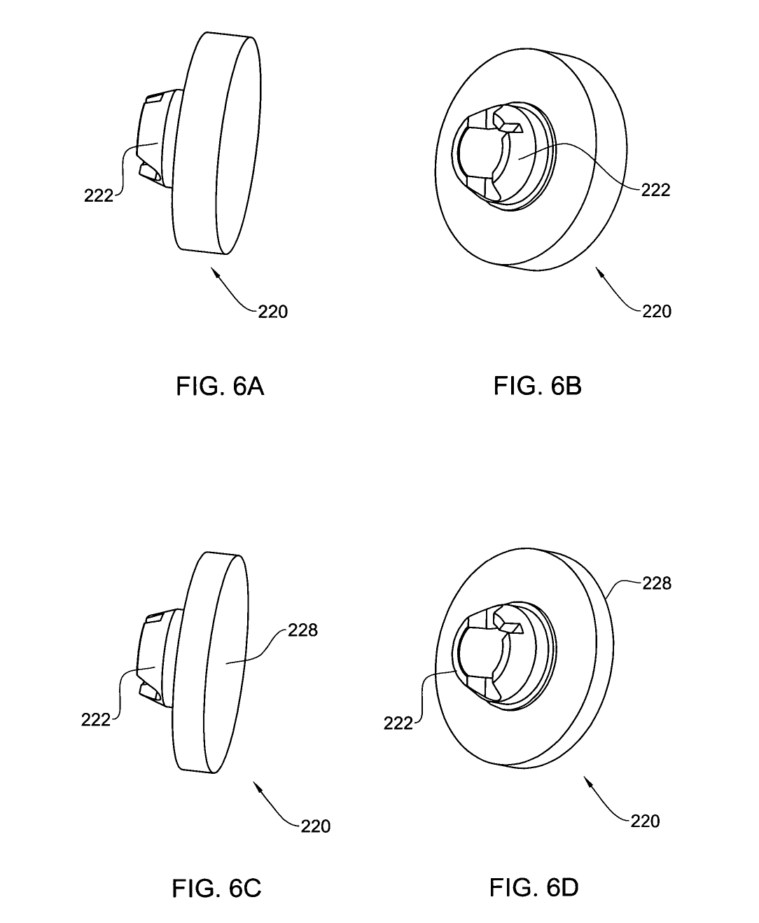

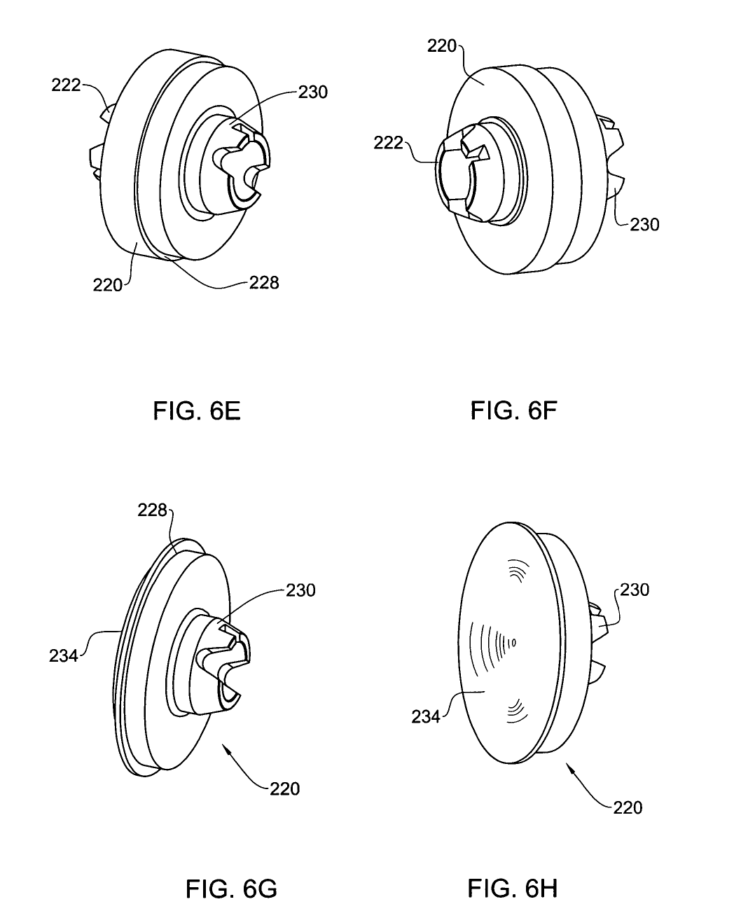

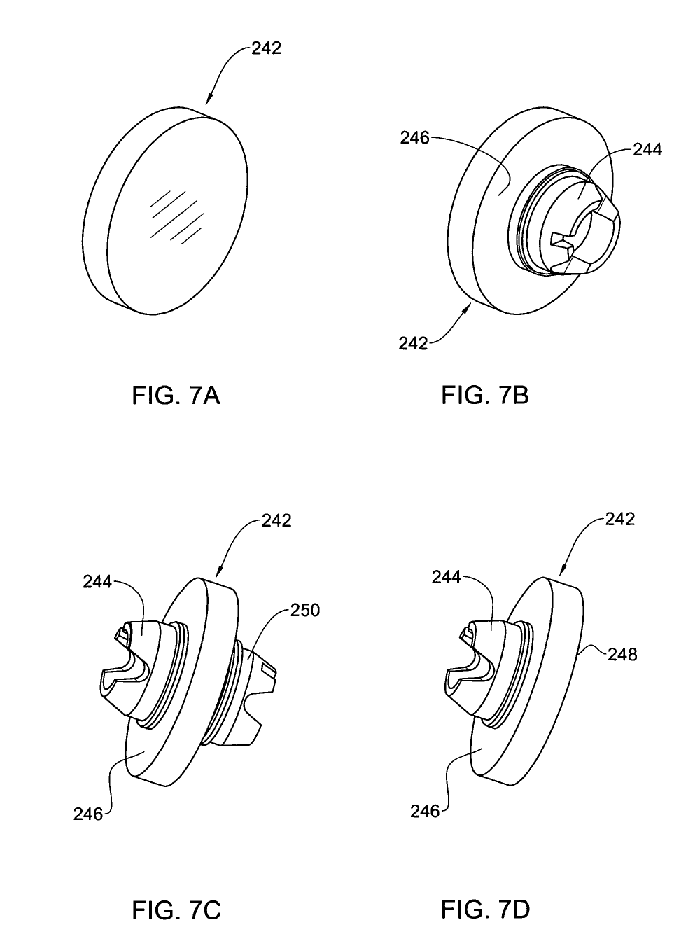

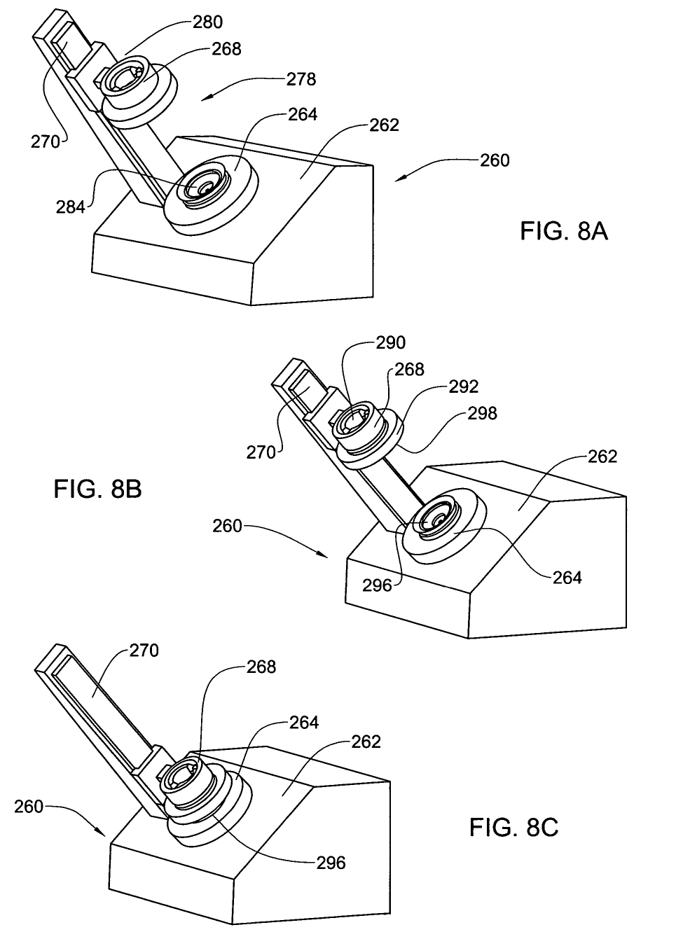

With reference being made now to FIGS. 5A and 5B, there is illustrated a lens blank 186 similar to lens blank 10 of FIG. 1A, having a disc-like shaped formed with an annular rim 188 radially projecting. The lens blank may be preformed with reference datum indications as discussed in connection with the embodiments of FIGS. 1A to 1C, and also with some pre-forming of the optical topography of the lens surfaces. However, according to the present embodiment, these are not requirements. Instead, the lens blank 186 is fixedly secured within an adapter ring 190 (e.g. by a locking ring, a bayonet-type engagement, adhering by various means such as wood alloy or other adhesive material, etc). However, it is appreciated that the lens blank material may be molded into the adapter ring.

In turn, the adapter ring 190 is pre-formed with such reference datum indications, which are, in the present example the height H of the adapter ring, the concentricity and tapering of sloping surfaces 194 and 196, one or more true position indications or some other discrete indications such as hole 198.

After securing the lens blank 186 to the adapter ring 190, the ring is secured to a gripping device 202 (FIG. 5B) where positioning of the lens blank is governed by the reference datum indications of the adapter ring 190 in combination with corresponding portions of the gripping device 202, e.g. matching engagement of inclined surface 196 with corresponding surface 206 of the gripping device, projection of a positioning pin 208 into the hole 198, etc. According to this arrangement, there is no need to form the lens blank with any reference datum indications as these are provided by the adapter ring. Even more so, the subassembly of the lens blank and the adapter ring may be moved between different workstations while retaining the reference datum.

Whilst several embodiments have been shown and described, it is to be understood that it is not intended thereby to limit the disclosure, but rather it is intended to cover all embodiments, modifications and arrangements falling within the spirit and the scope of the present invention, as defined in the appended claims, mutatis mutandis.

1. A method for processing a first optical face and a second optical face of a lens, where a lens blank is positioned and gripped by a gripping device relying on reference datum indications rendering it possible to obtain topographic orientation for processing both faces of the lens, and wherein not more then one reference datum indication extends on a face of the lens.

2. A method according to claim 1, wherein all reference datum indications are formed on peripheral portions of the lens.

3. A method according to claim 1, wherein faces of the lens are not formed with any reference datum indications.

4. A method according to claim 1, wherein the reference datum indications are preformed on the lens blank.

5. A method according to claim 1, wherein the reference datum indications are formed on the lens blank during a machining step of the lens, prior to processing the second optical face thereof.

6. A method according to claim 1, wherein the reference datum indications are provided by an adapter assembly wherein the lens blank is received by a first component adapted for engagement with a second component associated with the gripping device; wherein said first component and said second component are formed with corresponding reference datum engagement portions.

7. A method according to claim 1, wherein orientation of the lens during its manufacture process is entirely mechanical.

8. A method according to claim 1, wherein blocking and gripping the lens blank during its manufacture process are entirely mechanical.

9. A method according to claim 4, wherein orientation of the lens blank is achieved by a set of full-spatial reference datum indications processed on the lens blank, indicative of the orientation of the lens blank, wherein said indications are not formed on a face of the lens.

10. A method according to claim 1, wherein the gripping means is integral with or attachable to the lens processing equipment.

11. A method for processing optical faces of a lens, comprising the following steps:
(a) Obtaining a lens blank;
(b) Gripping the lens blank by a gripping device for use in conjunction with a lens processing machine;
(c) Processing the lens blank to obtain full-spatial reference datum indications and processing a first optical face of the lens whereby said reference datum indications define the coordinates of the lens with respect to said first optical face; and wherein not more then one reference datum indication extends on the optical face of the lens;
(d) Turning over the lens blank and gripping it while relying on said reference datum indications; and
(e) Processing a second optical face of the lens.

12. A method according to claim 11, wherein before step (d), a removable structural support material is applied into a cavity formed adjoining said first optical face, to thereby facilitate processing the second optical lens face.

13. A method according to claim 9, wherein before step (c), a first side of the lens is formed with an anchoring arrangement to increase attachment of the structural support material to the lens.

14. A method according to claim 13, wherein the anchoring arrangement is a peripheral recess.

15. A method according to claim 12, wherein the surface of the first optical face is coated with a protective material prior to applying the structural support material.

16. A method according to claim 11, wherein before step (d) the surface of the first optical face is finished.

17. A method for processing optical faces of a lens, comprising the following steps:
(a) Obtaining a lens blank;
(b) Gripping the lens blank by a gripping device for use in conjunction with a lens production machine;
(c) Processing the lens blank to obtain full-spatial reference datum indications and processing a first optical face of the lens whereby said reference datum indications define the coordinates of the lens with respect to said first optical face; and wherein not more then one reference datum indication extends on the first optical face of the lens;
(d) Blocking the first optical face of the lens to a blocking chuck, where reference datum indications of the blocking chuck are in register with the reference datum indications of the lens blank;
(e) Gripping the blocking chuck by the gripping device; and
(f) Processing a second optical face of the lens.

18. A method according to claim 17, wherein after step (c) the first optical face of the lens is finished.

19. A method according to claim 17, wherein the blocking chuck is a mobile device pre-formed with full-spatial mechanical true-position reference datum indications.

20. A method according to claim 11, wherein the blocking chuck is formed full-spatial mechanical and one optical true-position reference datum.

21. A method according to claim 20, wherein orientation of the blocking chuck with reference to the lens blank is based on a combination of mechanical and optical reference datum indications.

22. A method according to claim 17, wherein after step (c) a removable structural support material is applied into a cavity formed adjacent said first optical face, to thereby facilitate processing the second lens face.

23. A method according to claim 17, wherein one or both of the first optical face and the second optical face are finished at a later step.

24. A lens blank pre-formed with reference datum indications providing full-spatial reference datum, whereby the blank may than be gripped by a gripping device for use in conjunction with a lens processing apparatus, relying on said reference datum indications for gripping and processing a first optical face and a second optical face of the lens.

25. A lens blank according to claim 24, wherein not more then one reference datum indication extends on an optical surface of the lens.

26. A lens blank according to claim 24, wherein all reference datum indications extend out of the optical surfaces of the lens.

27. A lens blank according to claim 24, wherein at least one of the reference datum indications are formed on an annular rim on the periphery of the lens blank.

28. A lens blank according to claim 24, wherein at least one of the reference datum indications is formed by an annular recess on the periphery lens blank.

29. A lens blank according to claim 24, wherein one of the reference datum indications is a radial projection extending from a peripheral face of the lens blank.

30. A lens blank according to claim 24, wherein one of the reference datum indications is a radial indention extending from a peripheral face of the lens blank.

31. A lens blank according to claim 24, wherein one of the reference datum indications is a tapering peripheral surface of the lens blank.

32. A lens blank according to claim 24, wherein one of the reference datum indications is an axially extending indication.

33. A lens according to claim 32, wherein the axially extending indication is a recess.

34. A lens blank according to claim 24, wherein the reference datum is a set of pre-formed apertures or recess.

35. A lens blank according to claim 24, comprising at least one discrete reference datum indication for ensuring true-position of the lens.

36. A lens blank according to claim 24, wherein one or both of the first optical face and the second optical face are at least partially pre-formed with optical topography.

37. A method for processing optical faces of a lens, comprising the following steps:
(a) Obtaining a lens blank pre-formed with reference datum indications providing full-spatial reference datum indications sufficient for processing a first optical face and a second optical face of the lens;
(b) Gripping the lens blank by a gripping device for use in conjunction with a lens production apparatus and processing the first optical face of the lens relying on said reference datum indications; wherein not more then one reference datum indication extends on an optical surface of the lens;
(c) Turning over the lens blank and gripping it while relying on said reference datum indications; and
(d) Processing the second optical face of the lens.

38. A method for processing optical faces of a lens, comprising the following steps:
(a) Obtaining a lens blank pre-formed with reference datum indication providing full-spatial reference datum indications sufficient for processing a first optical face and a second optical face of the lens;
(b) Gripping the lens blank by a gripping device for use in conjunction with a lens production apparatus and processing the first optical face of the lens relying on said reference datum indications; wherein not more then one reference datum indication extends on an optical surface of the lens
(c) Blocking the first optical face of the lens to a blocking chuck, where reference datum indications of the blocking chuck are in register with the reference datum indications of the lens blank;
(d) Gripping the blocking chuck by a gripping device for use in conjunction with a lens production apparatus; and
(e) Processing the second optical face of the lens.

39. A method according to one of claims 17, 37 and 38, wherein before step (d), a removable structural support material is applied into a cavity formed adjoining said first optical face, to thereby facilitate processing the second lens face.

40. An adapter for use in the processing of an optical lens, the adapter comprising a lens blank receiving zone for receiving and fixedly supporting a lens blank, and an engagement zone for engagement with a gripping device for use in conjunction with a lens processing apparatus, said engagement zone comprising reference datum indications providing full-spatial orientation for processing at least a first optical face of the lens.

41. An adapter according to claim 40, wherein the adapter comprises a lens blank receiving member formed with said reference datum indications and adapted for engagement with a mating gripping device fitted with mating reference datum indications corresponding with those of said lens blank receiving member.

42. An adapter according to claim 41, wherein said lens blank receiving member comprises a lens blank locking arrangement.

43. An adapter according to claim 42, wherein the lens blank receiving member is formed with at least one tapering surface.

44. An adapter according to claim 42, wherein the lens blank receiving member is formed with at least one rotational datum reference indication.

45. An adapter according to claim 42, wherein the lens blank receiving member is formed with at least a flat face extending normal to a longitudinal axis of the adapter.

46. A method for processing optical faces of a lens wherein processing optical faces of the lens is carried out while a lens blank is gripped at peripheral surfaces thereof.

47. A method for processing optical faces of a lens wherein gripping a lens blank during processing optical faces of the lens is carried out by gripping the blank at portions of the blank having a radius greater then that of the processed optical faces.

48. A method for processing optical faces of a lens wherein processing optical faces of the lens is carried out while a lens blank is directly gripped.
